(19) United States
(12) Patent Application Publication
(10) Pub. No.: US 2015/0267855 A1
(43) Pub. Date: Sep. 24, 2015

(54) INSTALLATION AID FOR WATER PIPELINE REPAIR CLAMP

(71) Applicant: The Ford Meter Box Company, Inc., Wabash, IN (US)

(72) Inventors: SINJON BRADBERRY, VESTAVIA HILLS, AL (US); WILLIAM HICKS, MOODY, AL (US)

(21) Appl. No.: 14/662,832

(22) Filed: Mar. 19, 2015

Related U.S. Application Data
(60) Provisional application No. 61/968,564, filed on Mar. 21, 2014.

(51) Int. Cl. F16L 55/172; F16L 21/06

(52) U.S. Cl. CPC F16L 55/1725; F16L 21/065

(57) ABSTRACT

A repair clamp assembly is provided which includes a clamp member, a lug, and a bolt. The clamp member is configured to wrap around a pipe. The lug is attached to the clamp member and is configured to tighten the clamp member around a pipe. The bolt engages the lug and is configured to tighten the clamp member around a pipe with the lug. The bolt includes a fastener portion configured to attach to the lug, and a handle spaced apart from the fastener portion. Lastly, the handle is configured to carry and transport the repair clamp assembly when the bolt is attached to the lug. The handle portion may then be selectively removed when the repair clamp is positioned in place or the handle is no longer needed.

### RELATED APPLICATION

This application claims the benefit of U.S. Provisional Application Ser. No. 61/968,564, filed Mar. 21, 2014, entitled “Installation Aid for Water Pipeline Repair Clamp” which is hereby incorporated by reference in its entirety.

### TECHNICAL FIELD AND SUMMARY

The present disclosure relates to pipe repair clamps. More particularly, the present disclosure relates to pipe repair clamps having a bolt that includes improved installation and handling characteristics.

Pipe sections in the waterworks industry are subject to various types of damage, erosion, or corrosion that result in an aperture on the pipe. In a pressurized system this aperture causes the pipe to leak. These leaks are detrimental and must be corrected. A temporary means of repairing is a repair clamp. A typical repair clamp consists of a stainless steel band secured as a cylinder by lugs. A pad or mat style synthetic rubber gasket is coupled to the stainless steel band. The clamp is placed over the leaking pipe with the pad gasket contacting the pipe surface. Fasteners secure the lugs at the ends of the band which forms the cylinder. The fasteners are tightened to a specified level of torque to place force on the pad gasket. This force causes the stainless steel band and the pad gasket to conform to the surface of the pipe and create seals around any damaged areas of the pipe.

Repair clamps may be utilized on a variety of pipe types and sizes and are typically formed during manufacture to fit a specific size range of pipe outer diameters. Repair clamps may also be made in multiple sections to allow use on larger pipe sizes and various widths to accommodate different types of damage. The installation process requires the installer to open the formed repair clamp and pull the band(s) around the pipe. One illustrative style of repair clamp uses a cast ductile iron lug structure to house the clamping fasteners. The lugs are typically joined to the stainless band by mechanical means. The fasteners are then contained in the lugs.

There are typically two different lugs that are joined together during installation. One of the lugs will have a closed loop structure that encapsulates a bolt while the opposite structure will have an open, slotted loop that allows the bolt to be assembled in the lug without removal of the nut. This allows the clamp to be installed on a pipe section without disassembly of the fasteners.

The bolt is typically designed to engage the lug in such a manner that it prevents rotation of the bolt after it is placed in the open loop. After the opposite end of the bolt that is encapsulated in the closed lug is placed in the open lug slot, the fasteners are tightened to apply force to the pad gasket. Joining the lugs to allow the bolt to be placed in the slotted lug can be difficult due to the lack of an effective method to grip the lugs. This difficulty may limit the effective application range of the clamp. Another type of repair clamp utilizes fabricated lug structures that are joined to the stainless steel band by welding. These fabrications also use open and closed lug structures that facilitate installation.

An illustrative embodiment of the present disclosure includes a pipe repair clamp having opposed lugs that are drawn together by an improved bolt. This bolt may have the characteristics of a T-shaped handle to aid in handling the clamp and installing it. It is appreciated that the bolt may be of any appropriate diameter, length, and/or geometry to fit pipe repair clamps of any variety of sizes. The bolt may also include an anti-rotation feature to prevent the bolt from inadvertently loosening once tightened on the clamp's lugs. In another embodiment, the bolt may include a nut fixed thereon so that when the bolt is coupled to the lugs, simply rotating the bolt draws the lugs together and tightens the clamp without separately affixing the nut.

Another illustrative embodiment of the present disclosure provides a repair clamp assembly comprising a clamp member, a lug, and a bolt. The clamp member is configured to wrap around a pipe. The lug is attached to the clamp member and is configured to tighten the clamp member around the pipe. The bolt engages the lug and is configured to tighten the clamp member around the pipe with the lug. The bolt includes a fastener portion configured to attach to the lug, and a handle spaced apart from the fastener portion. Lastly, the handle is configured to carry and transport the repair clamp assembly when the bolt is attached to the lug.

In the above and other illustrative embodiments, the repair clamp assembly may further comprise: the handle of the bolt having a shape selected from the group consisting of T-shaped and U-shaped; the bolt including an anti-rotation portion; the handle being configured to rotate the bolt and tighten the clamp assembly with a nut; the anti-rotation portion having a shape selected from the group consisting of ellipse, oval, square, triangular, trapezoid, and hexagonal, and wherein the anti-rotation portion being configured to fit in a correspondingly-shaped aperture on a mating component of the lug to prevent the bolt from rotating during tightening; the bolt including a break-off portion located adjacent the handle, wherein the handle being configured to be intentionally broken off after use; the bolt including a break-off portion located adjacent the handle, wherein the break-off portion is selected from the group consisting of a narrowed neck and a notched neck; and the fastener portion of the bolt being threaded and configured to engage corresponding threads in the lug.

Another illustrative embodiment of the present disclosure provides a repair clamp assembly that comprises a clamp member, a lug, and a bolt. The clamp member is, again, configured to wrap around a pipe. The lug is likewise attached to the clamp member and configured to tighten the clamp member around the pipe. Similarly, the bolt engages the lug and is configured to tighten the clamp member around a pipe with the lug. This bolt also includes first and second spaced apart fastener leg portions configured to attach to the lug, and a handle connected to both the first and second spaced apart fastener leg portions. The handle is configured to carry and transport the repair clamp assembly when the bolt is attached to the lug.

In the above and other illustrative embodiments, the repair clamp assembly may further comprise: the bolt being U-shaped; the bolt including an anti-rotation portion; the anti-rotation portion having a shape selected from the group consisting of ellipse, oval, square, triangular, trapezoid, and hexagonal, and wherein the anti-rotation portion is configured to fit in a correspondingly-shaped aperture on a mating component of the lug to prevent the bolt from rotating during tightening; the bolt including a break-off portion located adjacent the handle, wherein the handle is configured to be intentionally broken off after use; the bolt including a break-off portion located adjacent the handle, wherein the break-off portion is selected from the group consisting of a narrowed neck and a notched neck; and the first and second spaced apart fastener leg portions of the bolt are threaded and configured to engage corresponding threaded portions of the lug.

Another illustrative embodiment of the present disclosure provides a method of repairing a broken pipe. The method comprises the steps of: providing a repair clamp assembly that includes: a clamp member; a lug attached to the clamp member; and a bolt that engages the lug; the bolt includes a fastener portion and a handle wherein the handle is spaced apart from the fastener portion; carrying the repair clamp assembly by the handle of the bolt that is attached to the lug; lowering the repair clamp assembly by the handle of the bolt that is attached to the lug to a repair location; and manipulating the repair clamp assembly by the handle of the bolt that is attached to the lug to attach the repair clamp assembly to a pipe.

Additional features and advantages of the installation aid for a water pipeline repair clamp will become apparent to those skilled in the art upon consideration of the following detailed descriptions exemplifying the best mode of carrying out the installation aid for a water pipeline repair clamp as presently perceived.

### BRIEF DESCRIPTION OF THE DRAWINGS

The present disclosure will be described hereafter with reference to the attached drawings which are given as non-limiting examples only, in which:

FIG. 1 is an isometric view of a bolt according to an illustrative embodiment of the present disclosure;

FIG. 2 is an isometric view of the bolt of FIG. 1 assembled on a ductile lug-style repair clamp;

FIG. 3 is an isometric view of bolt of FIG. 1 as it would be utilized during installation on a pipe section;

FIG. 4 is an isometric view of another illustrative embodiment of a bolt that is used in a welded lug style clamp;

FIG. 5 is an isometric view of the bolt of FIG. 4 in use on a welded lug type clamp;

FIG. 6 is an isometric view of another illustrative embodiment of a bolt;

FIG. 7 is an isometric view of U-bolt design according to another illustrative embodiment of the present disclosure;

FIG. 8 is an isometric view of the U-bolt of FIG. 7 assembled on a ductile lug-style repair clamp;

FIG. 9 is an elevational view of another illustrative embodiment of a bolt having a break-off feature according to another illustrative embodiment of the present disclosure;

FIG. 10 is an isometric view of the bolt of FIG. 9 assembled on the ductile lug-style repair clamp;

FIG. 11 is an elevational view of another embodiment of a break-off style bolt according to another illustrative embodiment of the present disclosure; and

FIG. 12 is an elevational view of another embodiment of a bolt comprised of two parts with the intention that the parts will be utilized in conjunction with each other.

Corresponding reference characters indicate corresponding parts throughout the several views. The exemplification set out herein illustrates embodiments of the pipe repair clamp, and such exemplification is not to be construed as limiting the scope of the pipe repair claim in any manner.

### DETAILED DESCRIPTION OF THE DRAWINGS

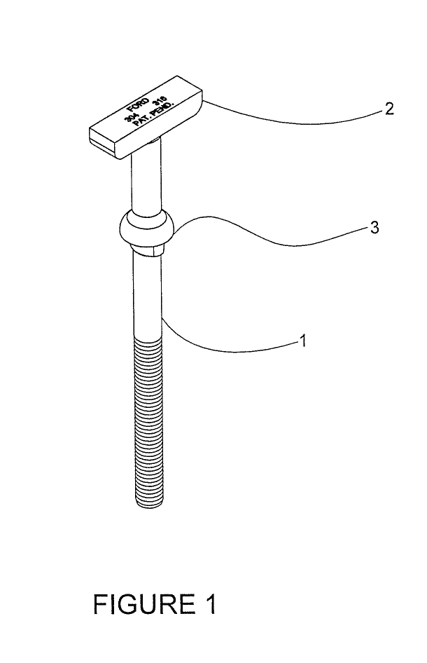

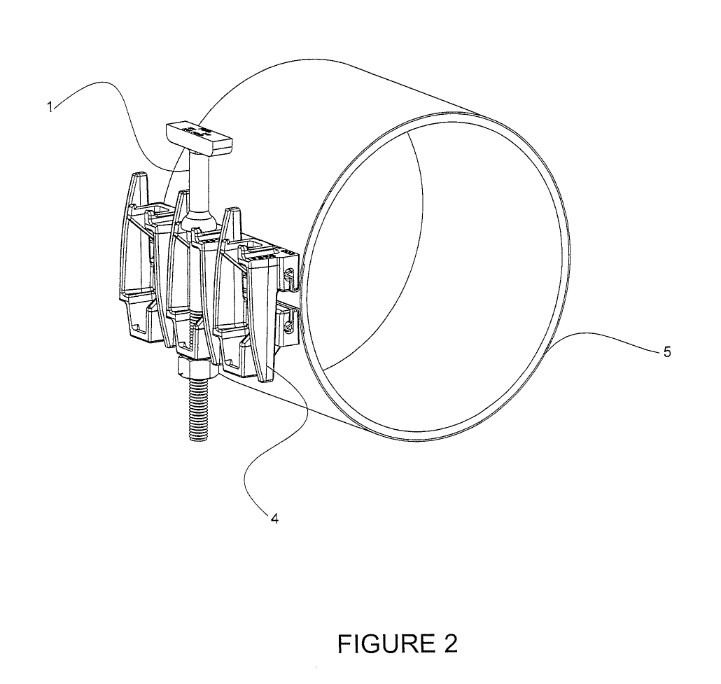

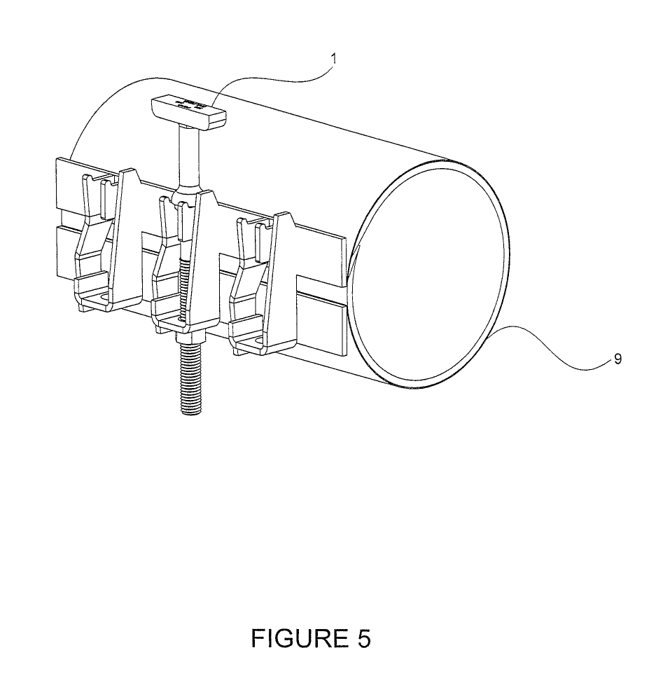

As shown in FIGS. 1-3, an illustrative embodiment of the present disclosure provides a bolt 1 that utilizes a T-shaped handle section 2 above the head of bolt 1 and an anti-rotation structure 3. The anti-rotation structure is an elliptical projection extending from the head of the bolt that is designed to fit in an elliptical-shaped aperture on mating components to prevent the bolt from rotating during tightening. Bolt 1 may be used on repair clamps (see FIGS. 2 and 5) of various configurations.

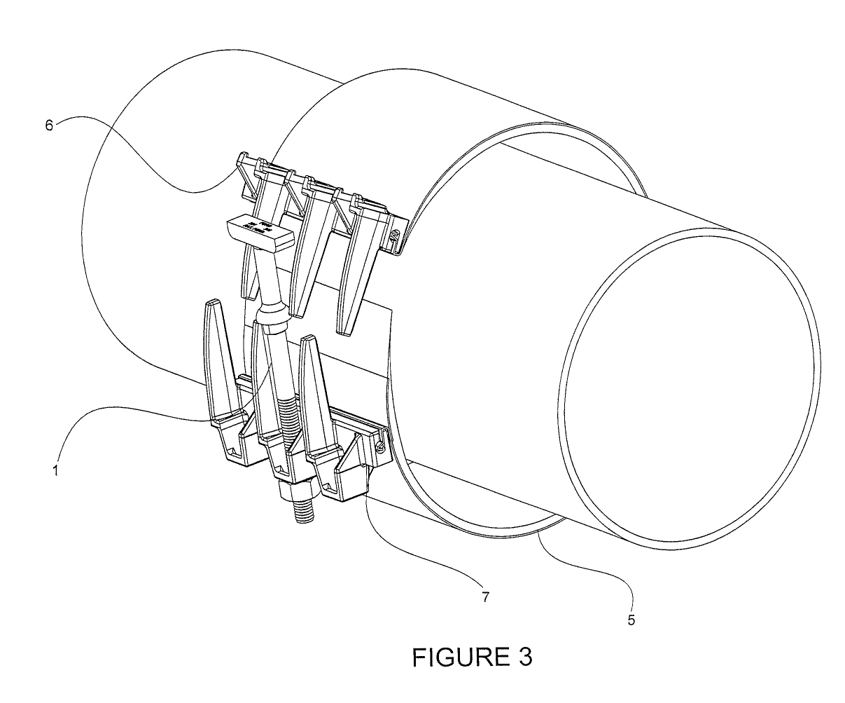

The use of bolt 1 on repair clamp 5 with ductile iron lugs 4 (also 6 and 7) is shown in FIGS. 2 and 3. Handle 2 on bolt 1, when attached to clamp 5, may be used as a clamp handle allowing safe and convenient transport of the repair clamp. This may be particularly useful when transporting clamp 5 down into an open trench to a leaking pipe. At the same time, handle 2 is also useful as an installation aid to facilitate joining the lugs during the repair clamp's field assembly. Handle 2 on bolt 1 allows the installer to position his or her body physically on the opposite side of the leak on a damaged pipe and swing the opened repair clamp around the pipe and easily pull the lugs together. It is further appreciated that bolt 1 may be used with cast or fabricated lugs. Bolt 1 may also utilize various projected geometries that are designed to fit similar-shaped apertures to prevent rotation of the bolt during tightening. These shapes include but are not limited to ellipses, ovals, squares, triangles, trapezoids, or hexagonal.

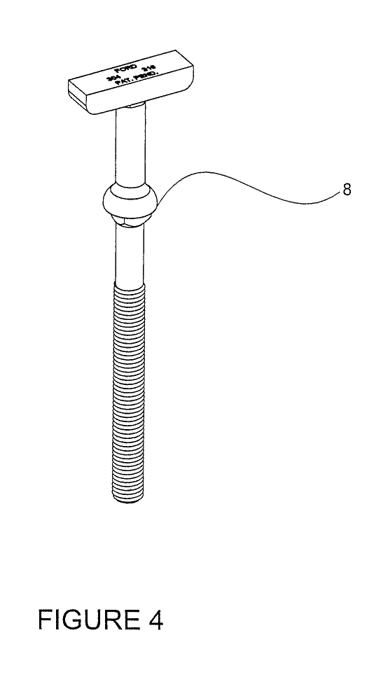

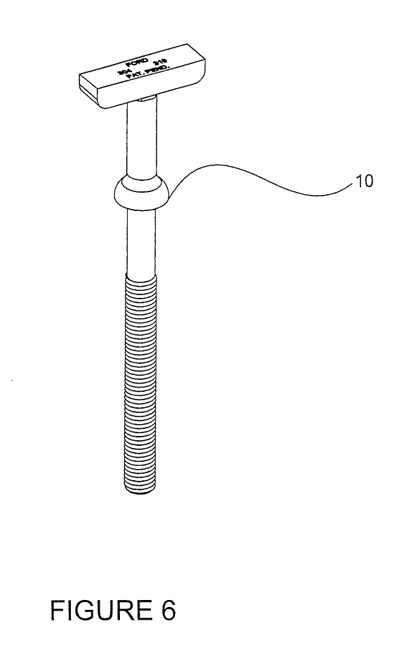

FIGS. 4 and 5 show bolt 1 in an alternate embodiment 8 with alternate clamp style 9. In another embodiment, bolt 10 may also be made without an anti-rotation geometry, as shown in FIG. 6. Handle 2 may be used to rotate and tighten bolt 1 with a nut. Bolt 1 may further be employed on other products of similar configuration that are utilized in the waterworks industry such as tapping sleeves and service saddles.

It is appreciated that these bolt configurations may serve to accomplish one or more of the following: provide a ductile iron lug stainless steel band repair clamp that may be installed more rapidly than current state-of-the-art repair clamps; provide a ductile iron lug stainless steel band repair clamp that is safer to transport and install than current state-of-the-art repair clamps; provide a ductile iron lug stainless steel band repair clamp that may have a larger application range than current state-of-the-art repair clamps; provide a welded lug stainless steel band repair clamp that may be installed more rapidly than current state-of-the-art repair clamps; provide a welded lug stainless steel band repair clamp that is safer to transport and install than current state-of-the-art repair clamps; and provide a welded lug stainless steel band repair clamp that may have a larger application range than current state-of-the-art repair clamps.

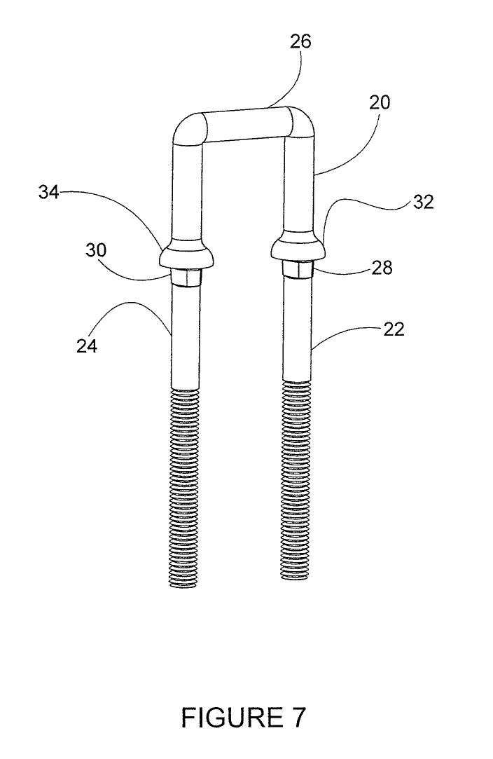

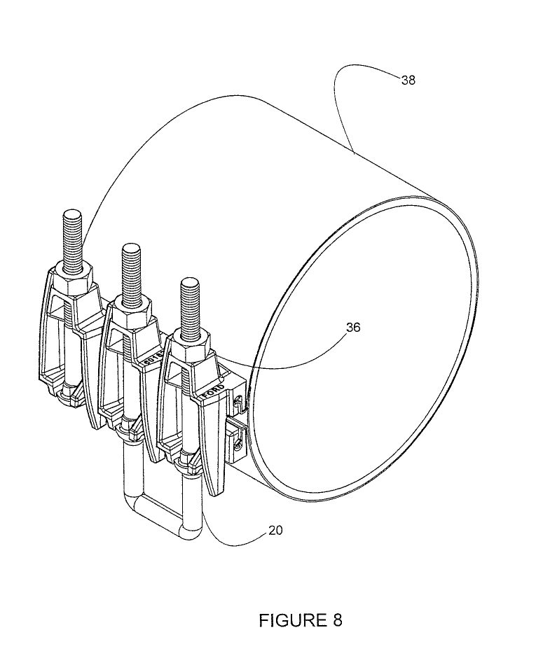

Another illustrative embodiment of a U-shaped bolt 20 is shown in FIGS. 7 and 8. In this embodiment, two bolt numbers 22 and 24 extend from a U-shaped handle 26. Legs 22 and 24 are illustratively threaded and include an anti-rotation feature 28 and 30 adjacent collars 32 and 34. Handle feature 26 may be gripped by an installer to carry bolt 20 along with the clamp.

As shown in FIG. 8, bolt 20 is attached to lug portion 36 of clamp 38. As shown in this embodiment, because typical repair clamps include lugs that accommodate a plurality of bolts, U-shaped bolt 20 is sized to occupy two bolt receptacles in lug 36. In this embodiment it is appreciated that a conventional bolt may occupy the third receptacle in lug 36. It is further evident from this view that the entire clamp 38 may now be easily carried by using U-shaped bolt 20 as a handle. And, as previously discussed, it therefore makes installation easier.

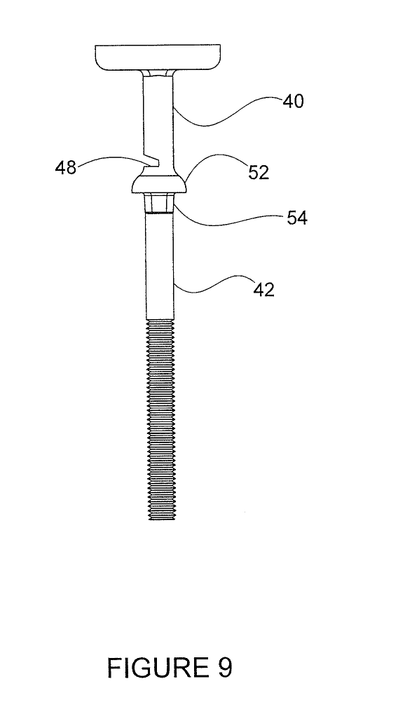

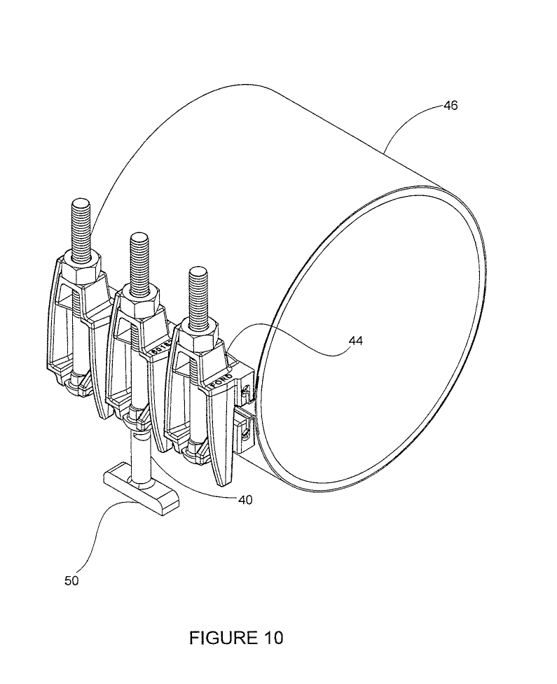

Another illustrative embodiment of the present disclosure includes a T-shaped handle 40 fastened to a clamp, as shown in FIGS. 9-11. In this illustrative embodiment, T-shaped handle 40 includes bolt leg 42 that may be threaded to attach to lug 44 on clamp 46. In contrast to prior embodiments, bolt 40 includes a break-off feature 48 located between handle 50 and collar 52. It is appreciated that once the clamp is installed in place, if for some reason the upwardly extending handle portion 50 is no longer necessary, it may be broken off during or after the repair, since it will no longer be needed at that point. It is also shown in this view the anti-rotation feature 54 located below collar 52. The view shown in FIG. 10 includes break-off bolt 40 attached to lug 44 of clamp 46. It is appreciated in this view how handle portion 50 of bolt 40 may be gripped by a person to carry clamp 46 to the installation site and to help manipulate the clamp 46 in place, like the previous embodiments.

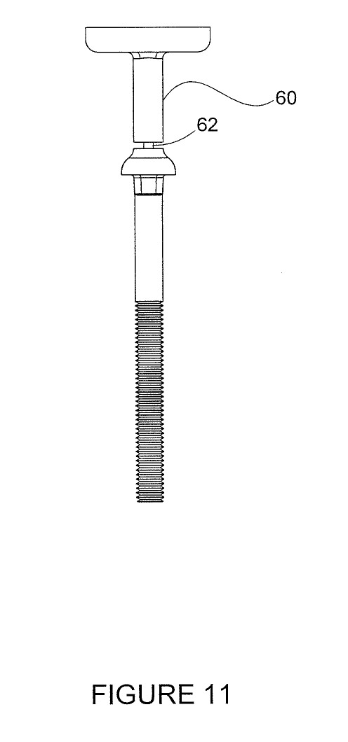

The view of bolt 60 shown in FIG. 11 is similar in design to bolt 40 of FIG. 9 except having a different break-off feature 62. This version is a narrowed neck rather than a notch.

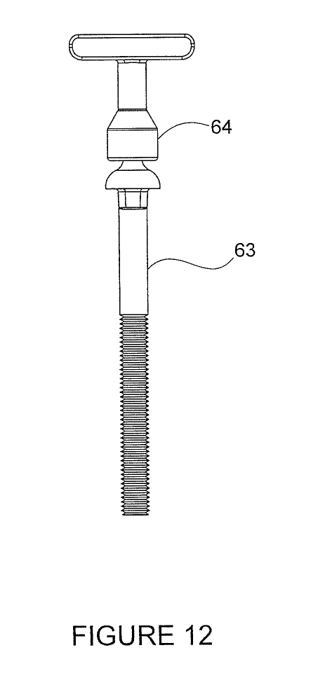

Another illustrative embodiment of the present disclosure includes a T-shaped handle 64 attached to bolt leg 63 as shown in FIG. 12. Like the prior embodiments, T-shaped handle 64 has a break off feature from bolt leg 63 to eliminate the handle after installation or when desired. In contrast with the other embodiments, handle 64 may be made of a different, less expensive material like plastic, etc., thereby serving the necessary function, but costing less to do so.

Although the present disclosure has been described with reference to particular means, materials, and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

What is claimed:

1. A repair clamp assembly comprising:
a clamp member configured to wrap around a pipe;
a lug attached to the clamp member and configured to tighten the clamp member around the pipe;
a bolt that engages the lug and is configured to tighten the clamp member around the pipe with the lug;
wherein the bolt includes a fastener portion configured to attach to the lug, and a handle spaced apart from the fastener portion; and
wherein the handle is configured to carry and transport the repair clamp assembly when the bolt is attached to the lug.

2. The repair clamp assembly of claim 1, wherein the handle of the bolt has a shape selected from the group consisting of T-shaped and U-shaped.

3. The repair clamp assembly of claim 1, wherein the bolt includes an anti-rotation portion.

4. The repair clamp assembly of claim 1, wherein the handle is configured to rotate the bolt and tighten the clamp assembly with a nut.

5. The repair clamp assembly of claim 3, wherein the anti-rotation portion has a shape selected from the group consisting of ellipse, oval, square, triangular, trapezoid, and hexagonal, and wherein the anti-rotation portion is configured to fit in a correspondingly-shaped aperture on a mating component of the lug to prevent the bolt from rotating during tightening.

6. The repair clamp assembly of claim 1, wherein the bolt includes a break-off portion located adjacent the handle, wherein the handle is configured to be intentionally broken off after its use is no longer needed.

7. The repair clamp assembly of claim 1, wherein the bolt includes a break-off portion located adjacent the handle, wherein the break-off portion is selected from the group consisting of a narrowed neck and a notched neck.

8. The repair clamp assembly of claim 7, wherein the break-off portion is made of a different material than the fastener portion of the bolt.

9. The repair clamp assembly of claim 1, wherein the fastener portion of the bolt is threaded and configured to engage corresponding threads in the lug.

10. A repair clamp assembly comprising:
a clamp member configured to wrap around a pipe:
a lug attached to the clamp member and configured to tighten the clamp member around the pipe;
a bolt that engages the lug and is configured to tighten the clamp member around the pipe with the lug;
wherein the bolt includes first and second spaced apart fastener leg portions configured to attach to the lug, and a handle connected to both the first and second spaced apart fastener leg portions; and
wherein the handle is configured to carry and transport the repair clamp assembly when the bolt is attached to the lug.

11. The repair clamp assembly of claim 10, wherein the bolt is U-shaped.

12. The repair clamp assembly of claim 10, wherein the bolt includes an anti-rotation portion.

13. The repair clamp assembly of claim 12, wherein the anti-rotation portion has a shape selected from the group consisting of ellipse, oval, square, triangular, trapezoid, and hexagonal, and wherein the anti-rotation portion is configured to fit in a correspondingly-shaped aperture on a mating component of the lug to prevent the bolt from rotating during tightening.

14. The repair clamp assembly of claim 10, wherein the bolt includes a break-off portion located adjacent the handle, wherein the handle is configured to be intentionally broken off after its use is no longer needed.

15. The repair clamp assembly of claim 10, wherein the bolt includes a break-off portion located adjacent the handle, wherein the break-off portion is selected from the group consisting of a narrowed neck and a notched neck.

16. The repair clamp assembly of claim 10, wherein the first and second spaced apart fastener leg portions of the bolt are threaded and configured to engage corresponding threaded portions in the lug.
